(19) United States
(12) Patent Application Publication
(10) Pub. No.: US 2006/0283287 A1
(43) Pub. Date: Dec. 21, 2006

(54) Highly rugged lightweight connecting-rod

(75) Inventor: Gerold Pankl, Bruck a.d. Mur (AT)

Correspondence Address: GREENBLUM & BERNSTEIN, P.L.C., 1950 ROLAND CLARKE PLACE, RESTON, VA, 20191, US

(73) Assignee: O.ST. FEINGUSSGESELLSCHAFT M.B.H., Kapfenberg (AT)

(21) Appl. No.: 11/430,932

(22) Filed: May 10, 2006

(30) Foreign Application Priority Data
May 11, 2005 (AT) A 808/2005

(51) Int. Cl. F16C 7/00; F02B 75/32

(52) U.S. Cl. 74/579 E; 123/197.3

(57) ABSTRACT

The invention relates to a connecting rod (1) for racing engines with an upper connecting rod top end (2) and a lower connecting rod top end (3) and a hollow shank (6) that extends from a bearing region (4) of the upper connecting rod top end (2) to a bearing region (5) of the lower connecting rod top end (3). In order to create a connecting rod of this type, which can be embodied in a lightweight manner with thin walls in the shank area and nevertheless withstands high stresses, it is proposed according to the invention that at least one strut (7) is provided which runs from the shank (6) to the bearing region (5) of the lower connecting rod top end (3).

The invention relates to a connecting rod for racing engines with an upper connecting rod top end and a lower connecting rod top end and a hollow shank that extends from a bearing region of the upper connecting rod top end to a bearing region of the lower connecting rod top end.

In operation connecting rods are exposed to high alternating tension/compression stresses on which bending stresses and torsional stresses are superimposed. Each one of these different kinds of stresses can vary considerably over the cross section and the length of a connecting rod. Furthermore, the cited stresses change during use, depending on the position of the connecting rod, and are therefore time-variable, so overall a complex stress profile results which a connecting rod must withstand during use.

For connecting rods for high-performance applications, in addition to the criterion for a high stability and long durability associated therewith, there is an additional criterion of embodying connecting rods to be lightweight in order to be able to achieve the highest possible engine speeds during operation.

One possibility of reducing weight for a connecting rod made, e.g., forged, from solid material lies in machining off material by means of milling from the surface of less stressed areas of the connecting rod. However, a subsequent milling for the purpose of reducing the weight of a connecting rod not only requires an additional process step in its production, but also entails the waste of high-quality material. The accessibility of the surface of a connecting rod for a milling cutter, and thus also the possibility of removing material by machining, is also limited. The tendency is therefore now to manufacture connecting rods with a hollow shank and to thus reduce the weight of the connecting rod.

Thus a connecting rod produced by precision-casting is known from EP 0 411 763 A2, the shank of which running cylindrically and parallel to a connecting rod axis is embodied to be essentially hollow. According to this printed publication it is possible to produce connecting rods, the wall thickness of which in the shank area is 0.5 to 0.75 mm.

According to DE 197 53 358 A1, which describes another connecting rod with hollow shank, a precision-cast connecting rod according to EP 0 411 763 A2 is not suitable for high-performance piston engines because of its weight. In DE 197 53 358 A1 it is therefore proposed to produce connecting rods with a hollow shank by connecting two thin-walled profile halves comprising a titanium alloy to one another forming a closed cavity along a joint seam running essentially in the longitudinal direction of the connecting rod. Such connecting rods are also considered suitable for high-performance piston engines.

Connecting rods with a hollow shank according to the prior art presented above can be produced in a lightweight manner per se. However, there are limits to a lightweight construction method according to the prior art in that the wall of the shank at any rate has to be thick enough to withstand the various stresses during operation. This represents a considerable restriction in particular for connecting rods for racing engines, which are exposed to the highest stresses: the higher the stresses, the thicker the walls required. However, a higher weight of a connecting rod has a negative impact on a maximum achievable engine speed, which, particularly in the case of racing engines, should be high. Therefore dilemma, as it were, exists, since on the one hand highest speeds are to be achieved with racing engines, which, i.a., requires connecting rods to be as light as possible, however, on the other hand, precisely in these applications such high stresses occur that connecting rods with correspondingly great wall thickness in the shank area are necessary.

Based on the prior art, the object of the invention is now to disclose a connecting rod of the type mentioned at the outset, which can be formed in a lightweight manner with thin walls in the shank area and nevertheless withstands high stresses.

This object is attained with a connecting rod according to claim 1. Advantageous further developments of a connecting rod according to the invention are the subject matter of dependent claims 2 through 14.

The advantages achieved with the invention are to be seen in particular in that with the aid of the at least one strut provided, which runs from the shank to the bearing region of the lower connecting rod top end, forces acting during the use of the connecting rod are divided or distributed in a favorable manner. As is known, during use a connecting rod is subjected to tensile load and/or compressive load via a piston pin connected to the upper connecting rod top end and a crankshaft connected to the lower connecting rod top end, depending on its position. Whereas hitherto all of the corresponding forces have had to be absorbed by the hollow shank, according to the invention a division of the forces is now given, because a part of the forces is guided via the strut provided from the shank to the bearing region of the lower connecting rod top end. Thus a force acting in the shank area is lower than with connecting rods according to the prior art. This has two consequences: firstly, if it is to withstand the same stresses as conventional connecting rods, a connecting rod according to the invention can be embodied with comparatively lower weight, since the walls of the shank can be manufactured to be thinner than before and a material saving associated therewith is greater than an additional material expenditure for the at least one strut. Secondly, if a maximum weight of the connecting rod is predetermined as a fixed value, this can now be stressed more since a distribution of the power flow in the connecting rod is optimized.

Seen from a different angle, it can be said that it was realized for the first time within the scope of the invention that the limits of the prior art identified above can be overcome, if as little material as possible is used for the manufacture of a connecting rod and this is distributed within the volume of the connecting rod such that during stress an optimal power flow in the connecting rod is possible.

It is preferred if the shank is embodied with at least one strut, which runs from the shank to the bearing region of the upper connecting rod top end. In this case, e.g., a power flow from the bearing region of the upper connecting rod top end to the bearing region of the lower connecting rod top end and vice versa is possible, which turns out to be favorable with regard to a high stress resistance of the connecting rod with alternating tensile load and compressive load.

The at least one strut can fundamentally run from an outer surface of the shank to a bearing region. However, it is preferred if the strut(s) is (are) arranged in the cavity of the connecting rod, because struts running in the cavity are protected from outside influences. A material expenditure for one or more struts is then also lower, because shorter distances are to be spanned inside the connecting rod than on the outside thereof.

In order to distribute acting forces as well as possible, it is very particularly preferred if several struts running from the shank to the bearing region of the lower connecting rod top end and/or several struts running from the shank to the bearing region of the upper connecting rod top end are provided, because a uniform distribution or dissipation of forces on the large bearing region is thus possible. This effectively counteracts high local peak loads due to tensile forces and compressive forces.

Furthermore, it is advantageous in order to achieve the most uniform possible distribution of forces over a cross section of the connecting rod perpendicular to its longitudinal axis, if the struts running to the bearing region of the lower connecting rod top end are embodied rotationally symmetrically to a connecting rod axis and/or the struts running to the bearing region of the upper connecting rod top end are embodied rotationally symmetrically to a connecting rod axis.

It also has a favorable effect if the strut or the struts is or are embodied as supports with an end broadening towards the shank and/or towards the bearing region. A stress on the struts in the shank/strut and bearing region/strut transition regions is kept low by a broadened end. On the other hand, the strut(s) can be embodied as support(s) in a material-saving manner in the low-stress areas.

With respect to the most efficient power flow in the connecting rod, it is preferred if the strut or struts is or are aligned to the connecting rod axis when seen from the shank-side end of the strut(s).

In a highly stress-resistant and yet lightweight variant of the invention, the shank is embodied essentially elliptically in a section crosswise to the connecting rod axis.

In order to distribute forces between the smaller upper connecting rod top end and the larger lower connecting rod top end or the corresponding bearing regions, if possible without the formation of pressure or tension peaks, the shank can be embodied with an increasing diameter in the direction from the upper connecting rod top end to the lower connecting rod top end. Since the tensile stress and compressive stress maximums decrease with increasing diameter, it can be provided in connection therewith that the shank is embodied with a decreasing wall thickness in the direction from the upper connecting rod top end to the lower connecting rod top end, which is advantageous with respect to a low overall weight of the connecting rod.

A connecting rod according to the invention can be produced in any manner per se. However, in order to be able to produce connecting rods with particularly thin walls, and at the same time to thereby be able to attach the struts to the connecting rod in a high-precision manner, it is advantageous if the connecting rod is precision-cast or produced by precision-casting.

In the context of a production in precision-casting it has proven advantageous if the shank is embodied in a reinforced manner in the edge region of a core mark opening. Though additional material must be provided for this on one side, the core mark is stabilized thereby so that it can be embodied with a large diameter on the other side. Overall, a material saving can therefore be achieved without a stress resistance of the connecting rod suffering. In addition, it can thereby be provided that the edge region embodied in a reinforced manner is connected to the bearing region of the lower connecting rod top end and/or the bearing region of the upper connecting rod top end via a reinforcement support, so that forces from the bearing region of the upper connecting rod top end can also be guided to the bearing region of the lower connecting rod top end via the edge region embodied in a reinforced manner.

In one embodiment the connecting rod according to the invention is formed of two parts, the connecting surface of which divides the lower connecting rod top end into two equal areas of the same size or volume. This embodiment permits a simple attachment of the same to a crankshaft. With respect to a low overall weight of the connecting rod, it is thereby preferred if both parts are embodied with a cavity.

Further advantages of the invention result from the context of the specification and the exemplary embodiment.

The invention is described in more detail below on the basis of an exemplary embodiment.

They show:

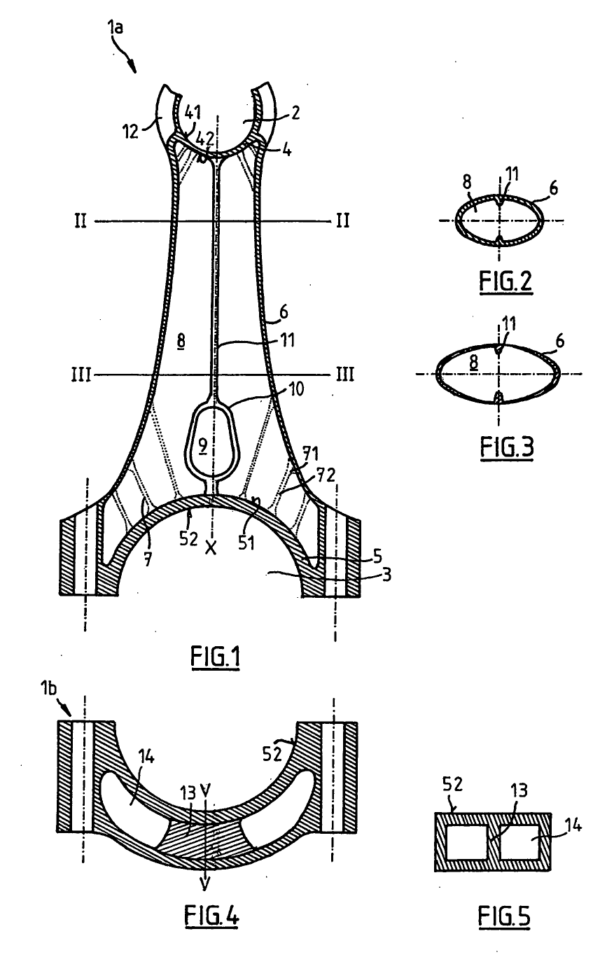

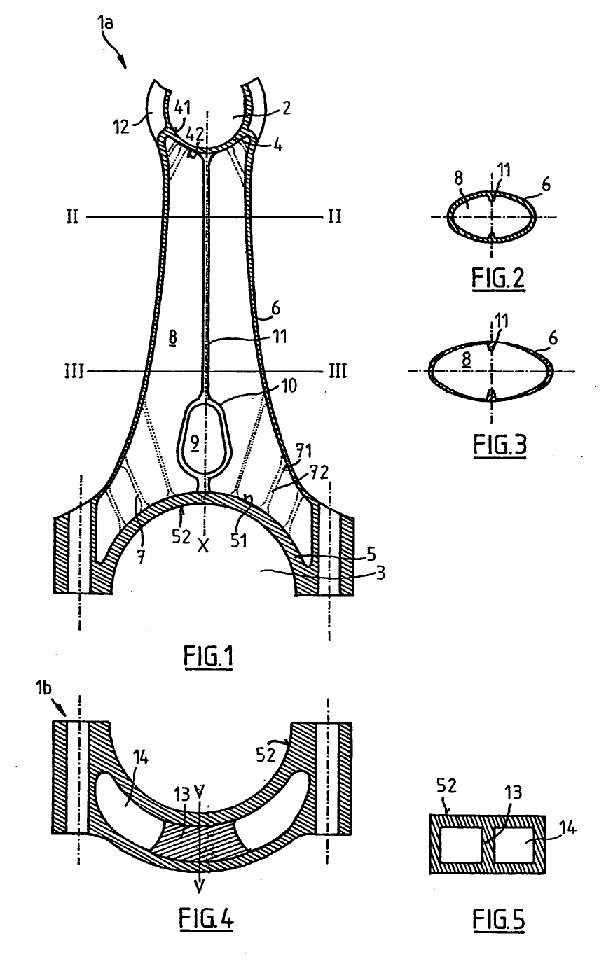

FIG. 1: The cross section of an upper part of a connecting rod comprising two parts;

FIG. 2: The cross section of a connecting rod in the plane II-II according to FIG. 1;

FIG. 3: The cross section of a connecting rod in the plane III-III according to FIG. 1;

FIG. 4: The lower part of a connecting rod comprising two parts, which lower part correlates with the upper part according to FIG. 1; and

FIG. 5: The cross section of a connecting rod in the plane V-V according to FIG. 4.

FIG. 1 shows the upper part 1a of a two-part connecting rod according to the invention with a hollow shank, which connecting rod was produced by precision-casting. The upper part 1a has at one end of its longitudinal extension a circular upper connecting rod top end 2 not shown in full, which can receive a piston pin and is surrounded by a bearing region 4 or is defined by the inner surface 41 thereof. At the opposite end of the part 1a there is one half of a likewise circular lower connecting rod top end 3, the diameter of which is greater than that of the upper connecting rod top end 2. The lower connecting rod top end 3 is surrounded by a bearing region 5, the surface 52 of which bears against a crankshaft during use.

The bearing region 4 of the upper connecting rod top end 2 and the bearing region 5 of the lower connecting rod top end 3 are connected by a shank 6 which has a cavity 8. In accordance with the larger diameter of the lower connecting rod top end 3, the shank 6 is embodied to broaden or diverge in the direction from the upper connecting rod top end 2 to the lower connecting rod top end 3 in order to achieve a uniform force distribution. In connection therewith a plurality of struts 7 is provided which extend from the shank 6 to the bearing region 5 of the lower connecting rod top end 3 or from the shank 6 to the bearing region 4 of the upper connecting rod top end 2. Seen from the shank 6, the struts 7 run respectively in the direction of the connecting rod axis X, which is defined by the center points of the circles of the upper connecting rod top end 2 and of the lower connecting rod top end 3, and are arranged symmetrically around them. With alternating tensile load and/or compressive load of the connecting rod, this effects an optimal power flow from the bearing region 5 of the lower connecting rod top end 3 to the bearing region 4 of the upper connecting rod top end 2 or vice versa.

The struts 7 are embodied as supports 72, which are embodied with a widening 71 in areas that adjoin the shank 6 or the bearing regions 4, 5. This makes a positive contribution to a good dissipation of forces from a shank area towards the bearing regions 4, 5.

With respect to materials and constructive aspects, struts 7 can fundamentally be manufactured from different materials, e.g., in the form of steel tubes or fiber-reinforced light-alloy rods, and additional struts can be provided crosswise to the connecting rod longitudinal axis X from wall to wall, which brings additional advantages with respect to bending stress and torsional stress.

Manufacturing a connecting rod according to the invention is particularly simple if it is manufactured by precision-casting, since in this case the hollow connecting rod and the struts are produced in a single production step. Moreover, and more importantly, the connecting rod is produced from a single material, which brings about a mechanically lastingly durable connection or link of the struts 7 to the shank 6 and the bearing regions 42 and 51 facing the cavity 8. In particular the struts 7 can bear against the inner surface of the shank 6 enclosing the cavity 8, instead of running through the cavity 8 in a free-standing manner. Moreover, through a production by precision-casting, a wall thickness of the shank 6, and of other parts of a connecting rod, can be adjusted exactly so that production is possible in a material-saving manner, which in turn has an advantageous effect on maximal torques. As demonstrated, for example, by FIGS. 2 and 3, the shank 6 of a precision-cast connecting rod is produced with smaller wall thickness, the larger the free diameter of the shank 6. A design of the wall thickness such that the wall in cross section seen by itself always has essentially the same area, has thereby proven advantageous with respect to a material optimization. To put it another way, during stress the force/area ratio is constant in every position crosswise to the connecting rod and with respect to a maximum stress to be expected the wall of the shank 6 can be precisely designed therefor at every position. Within a cross-sectional area material can be distributed in a non-uniform manner or a wall thickness can vary depending on the strain to be overcome, as shown by FIG. 3.

With respect to FIG. 1, it should also be stated that a core mark opening 9, which is necessary with a precision-casting, is embodied with a reinforced edge region 10. It is thus possible to embody the core mark opening 9 with a size advantageous for production purposes, without the formation of a weak point disadvantageous for later uses. At the same time the reinforced edge region 10 is connected via reinforcing supports 11 to the bearing region 5 of the lower connecting rod top end 3 and to the bearing region 4 of the upper connecting rod top end, and thus actively integrated into the control of the power flow.

When a connecting rod according to the invention is manufactured by precision-casting, it can be equipped with further components or further embodied with respect to minimizing weight. It is thus advantageous if during the production by means of a precision-casting method a pipe is additionally provided in the cavity 8, which pipe connects the lower connecting rod top end 3 and the lower connecting rod top end 2, so that oil can flow between the connecting rod top ends and the connecting rod can be oiled or lubricated. It is also possible and expedient to embody further partial volumes of the connecting rod according to the invention to be hollow, e.g., a region 12 adjacent to the bearing region 4 of the upper connecting rod top end 2.

A lower part 1b of a connecting rod is shown in FIG. 4. This part 1b corresponds to part 1a of FIG. 1 and forms together therewith a connecting rod. Like part 1a, part 1b is also embodied with a cavity 14 in order to keep the overall weight of the connecting rod low. A brace 13 is mounted in the cavity 14, as FIG. 5 also shows, which brace, like the struts 7 in the cavity 8 of the shank 6, ensures a high mechanical stress resistance despite low weight.

### CROSS-REFERENCE TO RELATED APPLICATIONS

The present application claims priority under 35 U.S.C. §119 of Austrian Patent Application No. A 808/2005 filed May 11, 2005, the disclosure of which is expressly incorporated by reference herein in its entirety.

1. Connecting rod (1) for racing engines with an upper connecting rod top end (2) and a lower connecting rod top end (3) and a hollow shank (6) that extends from a bearing region (4) of the upper connecting rod top end (2) to a bearing region (5) of the lower connecting rod top end (3), characterized in that at least one strut (7) is provided which runs from the shank (6) to the bearing region (5) of the lower connecting rod top end (3).

2. Connecting rod (1) according to claim 1, characterized in that the shank (6) is embodied with at least one strut (7), which runs from the shank (6) to the bearing region (4) of the upper connecting rod top end (2).

3. Connecting rod (1) according to claim 1, characterized in that the strut(s) (7) is (are) arranged in the cavity (8) of the connecting rod (1).

4. Connecting rod (1) according to claim 1, characterized in that several struts (7) running from the shank (6) to the bearing region (5) of the lower connecting rod top end (3) and/or several struts (7) running from the shank (6) to the bearing region (4) of the upper connecting rod top end (2) are provided.

5. Connecting rod (1) according to claim 1, characterized in that the struts (7) running to the bearing region (5) of the lower connecting rod top end (3) are embodied rotationally symmetrically to a connecting rod axis (X) and/or the struts (7) running to the bearing region (4) of the upper connecting rod (2) are embodied rotationally symmetrically to a connecting rod axis (X).

6. Connecting rod (1) according to claim 1, characterized in that the strut or the struts (7) is or are embodied as supports (71) with an end (72) broadening towards the shank (6) and/or towards the bearing region (4, 5).

7. Connecting rod (1) according to claim 1, characterized in that the strut or struts (7) when seen from the shank-side end of the strut(s) (7) is or are aligned to the connecting rod axis (X).

8. Connecting rod (1) according to claim 1, characterized in that the shank (6) is embodied essentially elliptically in a section crosswise to the connecting rod axis (X).

9. Connecting rod (1) according to claim 1, characterized in that the shank (6) is embodied with an increasing diameter in the direction from the upper connecting rod top end (2) to the lower connecting rod top end (3).

10. Connecting rod (1) according to claim 9, characterized in that the shank (6) is embodied with a decreasing wall thickness in the direction from the upper connecting rod top end (2) to the lower connecting rod top end (3).

11. Connecting rod (1) according to claim 1, characterized in that the connecting rod (1) is precision-cast.

12. Connecting rod according to claim 11, characterized in that the shank (6) is embodied in a reinforced manner in the edge region (10) of a core mark opening (9).

13. Connecting rod (1) according to claim 12, characterized in that the edge region (10) embodied in a reinforced manner is connected to the bearing region (5) of the lower connecting rod top end (3) and/or the bearing region (4) of the upper connecting rod top end (2) via a reinforcing support (11).

14. rod (1) according to claim 1, characterized in that the connecting rod (1) is formed of two parts (1a, 1b), the connecting surface of which divides the lower connecting rod top end (3) into two equal areas of the same size or volume.

15. Connecting rod (1) according to claim 14, characterized in that both parts (1a, 1b) are embodied with respectively at least one cavity (8, 14).
